(19) United States
(12) Patent Application Publication
(10) Pub. No.: US 2021/0239549 A1
(43) Pub. Date: Aug. 5, 2021

(54) FIBER OPTIC DISTRIBUTED SENSING USING A CEMENT DEPLOYMENT SYSTEM

(71) Applicant: HALLIBURTON ENERGY SERVICES, INC., Houston, TX (US)

(72) Inventors: John Laureto MAIDA, Houston, TX (US); Christopher Lee STOKELY, Houston, TX (US)

(73) Assignee: HALLIBURTON ENERGY SERVICES, INC., Houston, TX (US)

(21) Appl. No.: 17/112,722

(22) Filed: Dec. 4, 2020

Related U.S. Application Data
(60) Provisional application No. 62/969,017, filed on Jan. 31, 2020.

(51) Int. Cl. G01L 1/24; E21B 47/135; G01K 11/32

(52) U.S. Cl. CPC G01L 1/242; G01K 2011/322; G01K 11/32; E21B 47/135

(57) ABSTRACT

Aspects of the subject technology relate to systems and methods for performing distributed measurements along a wellbore using distributed strain sensing with a distributed fiber optic sensing cable. Systems and methods are provided for utilizing a distributed fiber optic sensing cable connected to a cementing tool to obtain distributed strain sensing data along the wellbore. Distributed strain sensing data is obtained along the wellbore from the distributed fiber optic sensing cable. Distributed measurement pressure data is determined based on the distributed strain sensing data received from the distributed fiber optic sensing cable. A strain value is determined based on the distributed measurement pressure data and the distributed strain sensing data.

### CROSS-REFERENCE TO RELATED APPLICATIONS

This application claims the benefit of U.S. Provisional Application No. 62/969,017, filed on Jan. 31, 2020, the disclosure of which is hereby incorporated by reference in its entirety.

### TECHNICAL FIELD

The present disclosure relates generally to a cementing process, and more specifically (although not necessarily exclusively), to performing distributed measurements along a wellbore using a distributed fiber optic sensing cable during the cementing process.

### BACKGROUND

During completion of a wellbore, the annular space between the wellbore wall and a casing string (or casing) can be filled with cement. This process is referred to as “cementing” the wellbore. A bottom plug may be inserted into the casing string after which cement may be pumped into the casing string. A top plug may be inserted into the wellbore after a desired amount of cement has been injected. The top plug, the cement, and the bottom plug may be forced downhole by injecting displacement fluid into the casing string.

Using electrical pressure sensors downhole allows for detecting pressure changes within a wellbore. Fiber optic cables have also found application in downhole monitoring and understanding the geological conditions within a wellbore. There is a need to accurately obtain downhole pressure and/or temperature to determine attributes, such as the distribution of flow rates at perforations in the wellbore.

### BRIEF DESCRIPTION OF THE DRAWINGS

FIG. 1 illustrates a system for preparation and delivery of a cement composition to a wellbore in accordance with aspects of the present disclosure.

FIG. 2A illustrates surface equipment that may be used in placement of a cement composition in a wellbore in accordance with aspects of the present disclosure.

FIG. 2B illustrates placement of a cement composition into a wellbore annulus in accordance with aspects of the present disclosure.

FIG. 3 illustrates an example schematic diagram of a system for performing distributed measurements along a wellbore using distributed strain sensing with a fiber optic cable during a cementing process in accordance with aspects of the present disclosure.

FIG. 4 illustrates an example process for performing distributed measurements along a wellbore using distributed strain sensing with a fiber optic cable during a cementing process in accordance with aspects of the present disclosure.

FIG. 5 illustrates an example computing device architecture that can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be apparent from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

As used herein, “cement” is any kind of material capable of being pumped to flow to a desired location, and capable of setting into a solid mass at the desired location. “Cement slurry” designates the cement in its flowable state. In many cases, common calcium-silicate hydraulic cement is suitable, such as Portland cement. Calcium-silicate hydraulic cement includes a source of calcium oxide such as burnt limestone, a source of silicon dioxide such as burnt clay, and various amounts of additives such as sand, pozzolan, diatomaceous earth, iron pyrite, alumina, and calcium sulfate. In some cases, the cement may include polymer, resin, or latex, either as an additive or as the major constituent of the cement. The polymer may include polystyrene, ethylene/vinyl acetate copolymer, polymethylmethacrylate polyurethanes, polylactic acid, polyglycolic acid, polyvinylalcohol, polyvinylacetate, hydrolyzed ethylene/vinyl acetate, silicones, and combinations thereof. The cement may also include reinforcing fillers such as fiberglass, ceramic fiber, or polymer fiber. The cement may also include additives for improving or changing the properties of the cement, such as set accelerators, set retarders, defoamers, fluid loss agents, weighting materials, dispersants, density-reducing agents, formation conditioning agents, loss circulation materials, thixotropic agents, suspension aids, or combinations thereof.

The cement compositions disclosed herein may directly or indirectly affect one or more components or pieces of equipment associated with the preparation, delivery, recapture, recycling, reuse, and/or disposal of the disclosed cement compositions. For example, the disclosed cement compositions may directly or indirectly affect one or more mixers, related mixing equipment, mud pits, storage facilities or units, composition separators, heat exchangers, sensors, gauges, pumps, compressors, and the like used to generate, store, monitor, regulate, and/or recondition the exemplary cement compositions. The disclosed cement compositions may also directly or indirectly affect any transport or delivery equipment used to convey the cement compositions to a well site or downhole such as, for example, any transport vessels, conduits, pipelines, trucks, tubulars, and/or pipes used to compositionally move the cement compositions from one location to another, any pumps, compressors, or motors (e.g., topside or downhole) used to drive the cement compositions into motion, any valves or related joints used to regulate the pressure or flow rate of the cement compositions, and any sensors (i.e., pressure and temperature), gauges, and/or combinations thereof, and the like.

The disclosed cement compositions may also directly or indirectly affect the various downhole equipment and tools that may come into contact with the cement compositions/additives such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber-optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

In one aspect, a system includes a cementing tool positionable within a casing string of a wellbore and a distributed temperature sensing (DTS) system. The cementing tool in various aspects may be a cementing top plug or a cementing top plug dart. The DTS system may include a fiber optic cable coupled to the cementing tool; and a DTS interrogator positionable at a surface of the wellbore for transmitting an optical signal through the fiber optic cable and determining from a reflected optical signal a plurality of temperatures along the fiber optic cable. The system may further include a fiber reel for dispensing the fiber optic cable from a first end of the fiber optic cable in response to a tension in the fiber optic cable as the cementing tool travels down the casing string behind a cement composition. This system may also include a processor in communication with the DTS system, which is configured to monitor the plurality of temperatures along the fiber optic cable while the cement composition cures.

In one aspect, the processor is configured to identify, based on the plurality of temperatures, one or more of a top of cement within the wellbore, a loss zone within the wellbore or a first region of the wellbore that has more or less cement than a second region of the wellbore.

The processor may be configured to generate a notification in response to monitoring one or more unexpected temperatures based on one or more of a geothermal profile and a design schematic for the wellbore. Alternatively, or in addition, the processor may be configured to generate a visualization based on the plurality of temperatures for display on a display device. The visualization may include at least a portion of a temperature contrast map. In some aspects, the at least a portion of the temperature contrast map is comparatively displayed with at least a portion of a design schematic for the wellbore. The at least a portion of the temperature contrast map may be graphically superimposed upon the at least a portion of the design schematic or vice versa.

In one aspect, an artificial neural network (ANN) trained with temperature readings from wellbores including at least one known characteristic determines a correlation between at least one temperature at the at least one known characteristic.

In another aspect, the system includes an additional fiber reel for dispensing the fiber optic cable from a second end of the fiber optic cable. The fiber optic cable may be armored or unarmored fiber optic cable. The fiber reel, in some aspects, includes a drag device for preventing the dispensing the fiber optic cable in response to the tension in the fiber optic cable being less than a pre-set value.

In one aspect, a method includes coupling a fiber optic cable to a cement tool (e.g., cementing top plug or a cementing top plug dart) positionable within a casing string of a wellbore, wherein the fiber optic cable is a part of a DTS system further including a DTS interrogator positionable at a surface of the wellbore for transmitting an optical signal through the fiber optic cable and determining from a reflected optical signal a plurality of temperatures along the fiber optic cable. The method may also include coupling one end of the fiber optic cable to a fiber reel for dispensing the fiber optic cable as the cementing tool travels down the casing behind a cement composition. The method may further include dispensing, by the fiber reel, the fiber optic cable from an end of the fiber optic cable in response to a tension in the fiber optic cable. Finally, the method may include monitoring the plurality of temperatures via the DTS system while the cement composition cures.

In various aspects, the fiber optic cable is coupled to a light source, such as a laser, to measure distributions of pressure, temperature, and strain along the wellbore. The Brillouin scattering phenomenon is a phenomenon caused by power transfer via acoustic phonon when light is entered in an optical fiber. The frequency difference between the entered light and the Brillouin scattered light is referred to as Brillouin frequency. The Brillouin frequency is proportional to sound velocity in the optical fiber and the sound velocity depends on strain and temperature of the optical fiber. Hence, measurement of Brillouin frequency change allows for measurement of strain applied to and/or temperature of the optical fiber. Brillouin frequency changes with pressure applied to the optical fiber. The Rayleigh scattering phenomenon is a phenomenon caused by light scattering due to variation of the refractive index of an optical fiber. The frequency difference between the entered light and the Rayleigh scattered light is Rayleigh frequency. The Rayleigh frequency changes with strain applied to and/or temperature of the optical fiber.

In various aspects, the fiber optic cable can be dispensed (or unspooled) at one end by a reel (or bobbin) positioned proximate to the cementing tool. An additional reel can be positioned proximate to the surface of the wellbore and can also unspool additional lengths of the fiber optic cable. The fiber optic cable can be a sacrificial cable that remains within the wellbore until it, ultimately, is destroyed during wellbore operations, for example during stimulation.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

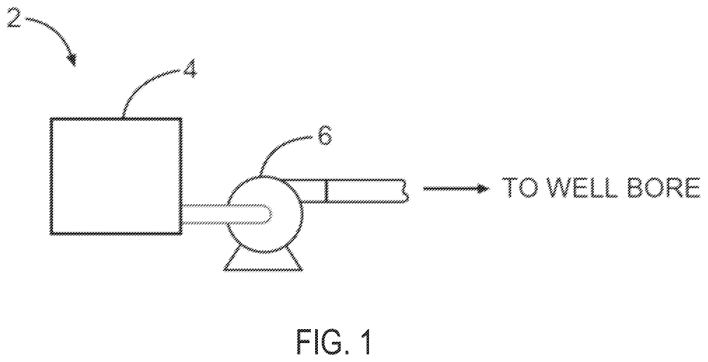

Referring now to FIG. 1, a system that may be used in cementing operations will now be described. FIG. 1 illustrates a system 2 for preparation of a cement composition and delivery to a wellbore in accordance with certain embodiments. As shown, the cement composition may be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 may be disposed on one or more cement trucks as will be apparent to those of ordinary skill in the art. In some embodiments, a jet mixer may be used, for example, to continuously mix the composition, including water, as it is being pumped to the wellbore.

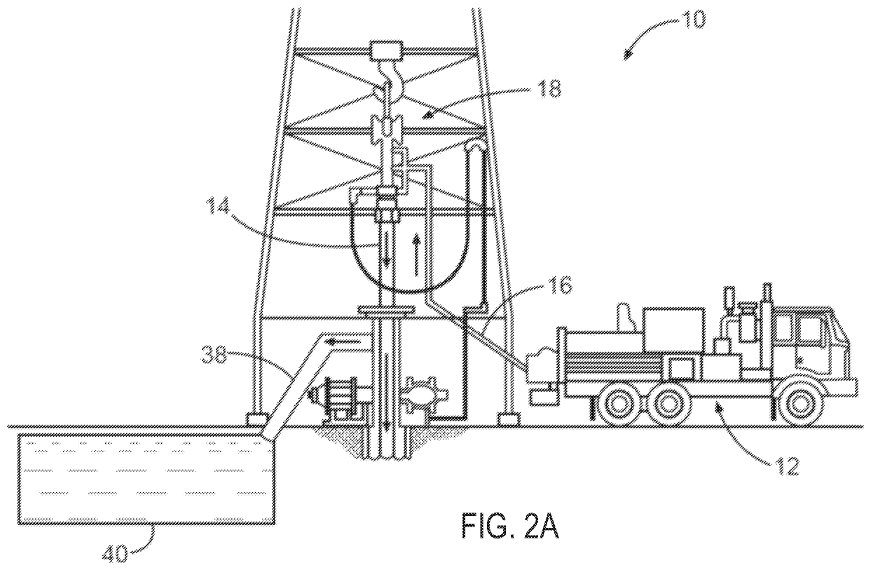

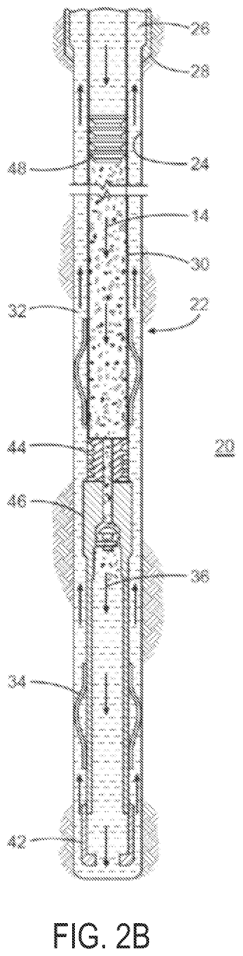

An example technique and system for placing a cement composition into a subterranean formation will now be described with reference to FIGS. 2A and 2B. FIG. 2A illustrates surface equipment 10 that may be used in placement of a cement composition in accordance with certain embodiments. It should be noted that while FIG. 2A generally depicts a land-based operation, those skilled in the art will readily recognize that the principles described herein are equally applicable to subsea operations that employ floating or sea-based platforms and rigs, without departing from the scope of the disclosure. As illustrated by FIG. 2A, the surface equipment 10 may include a cementing unit 12, which may include one or more cement trucks. The cementing unit 12 may include mixing equipment 4 and pumping equipment 6 (e.g., FIG. 1) as will be apparent to those of ordinary skill in the art. The cementing unit 12 may pump a cement composition 14 through a feed pipe 16 and to a cementing head 18 which conveys the cement composition 14 downhole.

Turning now to FIG. 2B, the cement composition 14 may be placed into a subterranean formation 20 in accordance with example embodiments. As illustrated, a wellbore 22 may be drilled into the subterranean formation 20. While wellbore 22 is shown extending generally vertically into the subterranean formation 20, the principles described herein are also applicable to wellbores that extend at an angle through the subterranean formation 20, such as horizontal and slanted wellbores. As illustrated, the wellbore 22 comprises walls 24. In the illustrated embodiments, a surface casing 26 has been inserted into the wellbore 22. The surface casing 26 may be cemented to the walls 24 of the wellbore 22 by cement sheath 28. In the illustrated embodiment, one or more additional conduits (e.g., intermediate casing, production casing, liners, etc.) shown here as casing 30 may also be disposed in the wellbore 22. As illustrated, there is a wellbore annulus 32 formed between the casing 30 and the walls 24 of the wellbore 22 and/or the surface casing 26. One or more centralizers 34 may be attached to the casing 30, for example, to centralize the casing 30 in the wellbore 22 prior to and during the cementing operation.

With continued reference to FIG. 2B, the cement composition 14 may be pumped down the interior of the casing 30. The cement composition 14 may be allowed to flow down the interior of the casing 30 through the casing shoe 42 at the bottom of the casing 30 and up around the casing 30 into the wellbore annulus 32. The cement composition 14 may be allowed to set in the wellbore annulus 32, for example, to form a cement sheath that supports and positions the casing 30 in the wellbore 22. While not illustrated, other techniques may also be utilized for introduction of the cement composition 14. By way of example, reverse circulation techniques may be used that include introducing the cement composition 14 into the subterranean formation 20 by way of the wellbore annulus 32 instead of through the casing 30.

As it is introduced, the cement composition 14 may displace other fluids 36, such as drilling fluids and/or spacer fluids that may be present in the interior of the casing 30 and/or the wellbore annulus 32. At least a portion of the displaced fluids 36 may exit the wellbore annulus 32 via a flow line 38 and be deposited, for example, in one or more retention pits 40 (e.g., a mud pit), as shown on FIG. 2A.

Referring again to FIG. 2B, a bottom plug 44 may be introduced into the casing 30 ahead of the cement composition 14, for example, to separate the cement composition 14 from the fluids 36 that may be inside the casing 30 prior to cementing. After the bottom plug 44 reaches the landing collar 46, a diaphragm or other suitable device ruptures to allow the cement composition 14 through the bottom plug 44. In FIG. 2B, the bottom plug 44 is shown on the landing collar 46. In the illustrated embodiment, a top plug 48 may be introduced into the wellbore 22 behind the cement composition 14. The top plug 48 may separate the cement composition 14 from a displacement fluid 53 and also push the cement composition 14 through the bottom plug 44.

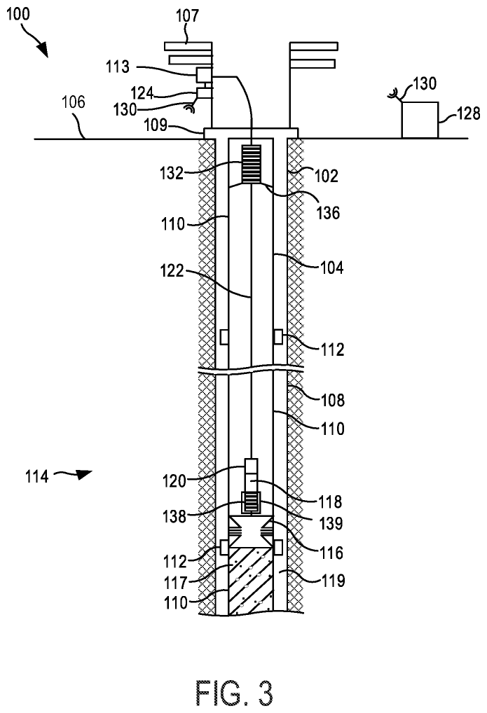

FIG. 3 is a schematic diagram of a system 100 for performing distributed measurements along a wellbore 102 using distributed strain sensing with a fiber optic cable 122 during a cementing process. The system 100 can include a wellbore 102 with a casing string 104 extending from the surface 106 through the wellbore 102. A blowout preventer 107 (“BOP”) can be positioned above a wellhead 109 at the surface 106. The wellbore 102 extends through various earth strata and may have a substantially vertical section 108. In some aspects, the wellbore 102 can also include a substantially horizontal section. The casing string 104 can include multiple casing tubes 110 coupled together end-to-end by casing collars 112. In some aspects, the casing tubes 110 are approximately thirty feet in length. The substantially vertical section 108 may extend/through a rock or hydrocarbon bearing subterranean formation 114.

A cementing tool, for example a cement plug 116, can be positioned downhole in the casing string 104. The cement plug 116 can be a top cement plug that is inserted into the casing string 104 after a desired amount of cement 117 has been injected into the casing string 104. In some aspects, a dart for plugging a cement plug can be used in place of the cement plug 116. The cement plug 116 can be forced downhole by the injection of displacement fluid from the surface 106. A bottom cement plug can be positioned below cement 117 and can be forced downhole until it rests on a floating collar at the bottom of the casing string 104. The cement plug 116 can be forced downhole until it contacts the bottom cement plug. The cement plug 116 can force the cement 117 downhole until it ruptures the bottom cement plug and is forced out of a shoe of the casing string 104. The cement 117 can then flow out of the casing string 104 and into the annulus 119 of the wellbore 102 as in a forward cementing process.

The cement plug 116 can be coupled to a locator device, such as magnetic pickup coil 118, which can generate a voltage in response to a change in a surrounding magnetic field. In one example, the locator device can be a magnetic pickup coil 118. In other examples, a piezoelectric sensor or other suitable locator device can be used by the system 100. The magnetic pickup coil 118 can include a permanent magnet with a coil wrapped around it. The casing tubes 110 can each emit a magnetic field. Each casing collar 112 can emit a magnetic field that is different from the magnetic field emitted by the casing tubes 110, which can be joined by the casing collar 112. The change in the magnetic field between the casing collars 112 and the casing tubes 110 can be detected by the magnetic pickup coil 118 of the system 100. The magnetic pickup coil 118 of the system 100 can generate a voltage in response to the change in the surrounding magnetic field when the magnetic pickup coil 118 passes a casing collar 112. The voltage generated by the magnetic pickup coil 118 can be in proportion to the velocity of the magnetic pickup coil 118 as the magnetic pickup coil 118 travels past the casing collar 112. In some aspects, the magnetic pickup coil 118 of the system 100 can travel between approximately 10 feet per second and approximately 30 feet per second.

The magnetic pickup coil 118 of the system 100 can be coupled to a light source, for example a light emitting diode (LED) 120. The voltage generated by the magnetic pickup coil 118 can momentarily energize the LED 120, which can be coupled to the magnetic pickup coil 118. The LED 120 can emit a pulse of light (e.g., an optical signal) in response to the voltage generated by the pickup coil 118. The LED 120 of the system 100 can transmit the pulse of light to a receiver 124 positioned at the surface 106. In some aspects, the LED 120 can operate at a 1300 nm wavelength and can minimize Rayleigh transmission losses and hydrogen-induced and coil bend-induced optical power losses. In some aspects, a high speed laser diode or other optical sources can be used in place of the LED 120 and various other optical wavelengths can be used. For example, wavelengths from about 850 nm to 2100 nm can make use of the optical low-transmission wavelength bands in ordinary fused silica multimode and single mode fibers.

The drive circuit of the LED 120 of the system 100 can require a minimum voltage be generated by the magnetic pickup coil 118 to complete the circuit and generate the pulse of light. In some aspects, the drive circuit of the LED 120 can be biased with energy from a battery or other energy source. The biased drive circuit of the LED 120 can require less voltage be induced in the magnetic pickup coil 118 to complete the circuit and generate the pulse of light. The biased drive circuit of the LED 120 can allow small changes in the magnetic field sensed by the magnetic pickup coil 118 to generate a sufficient voltage to energize the LED 120. In some aspects, the biased drive circuit of the LED 120 can allow the magnetic pickup coil 118, traveling at a low velocity, to pass a casing collar 112 and generate enough voltage to complete the circuit of the LED 120, thereby emitting a pulse of light. In some aspects, a light source can be positioned proximate to the surface 106 and can transmit an optical signal downhole to determine the location of a collar locator within the casing string 104.

The pulse of light generated by the LED 120 of the system 100 can be transmitted to the receiver positioned at the surface 106 using a distributed fiber optic sensor cable 122. The receiver 124 can be an optical receiver, for example the receiver 124 can be a photodetector that can convert the optical signals into electrical signals. In some aspects, the receiver 124 of the system 100 can count the number of pulses of light received via the fiber optic cable 122. The number of light pulses received by the receiver 124 can indicate the number of casing collars 112, the magnetic pickup coil 118, and plug 116 that have passed. The wellbore 102 can be mapped at the surface based on the number of casing tubes 110 positioned within the wellbore 102 and their respective lengths. The number of casing collars 112 and the cement plug 116 that have passed can indicate the position of the cement plug 116 within the wellbore 102. In some aspects, the receiver 124 can transmit information to the magnetic pickup coil 118 or other collar locator via the fiber optic cable 122 of the system 100.

In another example, the system 100 may include a light source that may be a laser 113 positioned at the surface 106 proximate to the BOP 107. The laser 113 can be coupled to the fiber optic cable 122, which can be dispensed at an end by the upper reel 132. The upper reel 132 can be positioned at the surface 106 proximate to the BOP 107. In some aspects, the laser 113 and the upper reel 132 can be positioned elsewhere at the surface 106 or within the wellbore 102.

The laser 113 of the system 100 can be a high repetition pulse laser or other suitable light source. The laser 113 of the system 100 can also generate an optical signal, for example, a series of light pulses that are transmitted by the fiber optic cable 122. The cement plug 116 of the system 100 can be coupled to the reel 138 and the magnetic pickup coil 118. A modulation device (e.g., a pendulum switch) can be coupled to the magnetic pickup coil 118 proximate to an end of the fiber optic cable 122. The modulation device can modulate the optical signal (e.g., pulses of light) generated by the laser 113 in response to a voltage generated by the magnetic pickup coil 118 as it passes a casing collar 112. In some aspects, a piezoelectric sensor or another suitable modulation device can be used to modulate the optical signal of the laser 113. In some aspects, the modulation device can modulate, for example but not limited to, the frequency, amplitude, phase, or other suitable characteristic of the optical signal. The optical signal generated by the laser 113 can travel the length of the fiber optic cable 122 and reach a lower end of the fiber optic cable 122 proximate to the lower reel 138.

The receiver 124 of the system 100 can be communicatively coupled to a computing device 128 located away from the wellbore 102 by a communication link 130. The communication link 130 may be a wireless communication link. The communication link 130 can include wireless interfaces such as IEEE 802.11, Bluetooth, or radio interfaces for accessing cellular telephone networks (e.g., transceiver/antenna for accessing a CDMA, GSM, UMTS, or other mobile communications network). In some aspects the communication link 130 may be wired. A wired communication link can include interfaces such as Ethernet, USB, IEEE 1394, or a fiber optic interface. The receiver 124 of the system 100 can transmit information related to the optical signal, for example but not limited to the light pulse count, the time the light pulse arrived, or other information, to the computing device 128. In some aspects, the receiver 124 of the system 100 can be coupled to a transmitter that communicates with the computing device 128.

Strain value based on the distributed measurement pressure data from the communication link 130 may be received by a computing device 128 via a network interface with a compatible communication link 130. In some aspects, the computing device 128 of the system 100 may use the interface to communicate with one or more networks, such as local area network (LAN) and/or wide area network (WAN), such as the Internet. The computing device 128 of the system 100 may also include a processor for processing the received the distributed measurement pressure data. The processor may be embodied, without limitation, as a microprocessor, application-specific integrated circuit (ASIC), digital signal processor (DSP), field-programmable gate array (FPGA) or the like. The processor may execute instructions stored in a storage device to perform aspects of the methods described herein. The storage device may also be used to store one or more logs, which may be embodied as any suitable data structure(s) for representing received and/or processed data. In one aspect, the computing device 128 may further include a user interface, such as a graphics card, for displaying graphics and/or text on a display device, such as a computer monitor. The user interface may display pressure and temperature based on the determined strain value.

The fiber optic cable 122 of the system 100 that transmits the light pulse to/from the LED 120 to the receiver 124 can be an unarmored fiber. The unarmored fiber can include a fiber core and cladding and a thin primary buffer coating but no outer jacket or secondary tight buffer to minimize fiber diameter for increased fiber length capacity of a given payout bobbin or reel. In some aspects, the fiber optic cable 122 of the system 100 can be an armored fiber. The armored fiber can include a fiber core, a cladding, a thin primary buffer coating an outer jacket or secondary tight buffer. The inclusion of the outer jacket or secondary tight buffer can increase the diameter of the fiber optic cable 122. The fiber optic cable 122 can be a multi-mode or single-mode optical fiber. The fiber optic cable 122 can include one or more optical fibers. The fiber optic cable 122 can be a sacrificial cable that is not retrieved from the wellbore 102 but instead remains in the wellbore 102 until it is destroyed. For example, the fiber optic cable 122 can be destroyed during stimulation of the wellbore 102.

The fiber optic cable 122 of the system 100 can also be dispensed from an upper bobbin or reel 132 positioned within the wellbore 102 proximate to the surface 106 as the cement plug 116 is forced downhole. In some aspects, the upper reel 132 can be positioned at the surface 106, for example the upper reel 132 can be positioned proximate to the blowout preventer 107. The upper reel 132 can be secured within the wellbore 102 by a securing device, for example by spring loaded camming feet 136 or other suitable securing mechanisms. The upper reel 132 of the system 100 can have a near-zero tension payout force that can allow dispensing of the fiber optic cable 122 when there is a tension in the fiber optic cable 122.

The fiber optic cable 122 of the system 100 can further be tensioned by and pulled along with the displacement fluid that is injected into the casing string 104 to move the cement plug 116. The upper reel 132 of the system 100 can dispense additional lengths of the fiber optic cable 122 as the fiber optic cable 122 is tensioned by the displacement fluid injected into the wellbore 102. In some aspects, the fiber optic cable 122 of the system 100 can spool off the upper reel 132 at the same rate as the flow of the displacement fluid. The upper reel 132 can prevent the fiber optic cable 122 from breaking or otherwise becoming damaged as the fiber optic cable 122 and the plug 116 travel downhole.

The fiber optic cable 122 of the system 100 can also be spooled on and dispensed from a lower bobbin or reel 138 positioned proximate to the magnetic pickup coil 118. The lower reel 138 can include a drag device 139. The drag device 139 can allow the lower reel 138 to dispense the fiber optic cable 122 only when a pre-set tension in the fiber optic cable 122 is reached. The lower reel 138 payout can prevent the fiber optic cable 122 from breaking or otherwise becoming damaged as the fiber optic cable 122 and the cement plug 116 travel downhole. The upper reel 132 and the lower reel 138 can store greater lengths of unarmored fiber optic cable than armored fiber optic cable. While FIG. 3 depicts the lower reel 138 positioned below the LED 120 and the magnetic pickup coil 118, in some aspects, the lower reel 138 can be positioned elsewhere with respect to the LED 120 and the magnetic pickup coil 118 of the system 100.

Referring to FIG. 3, the system 100 may further include permanently installed sensors. The sensors may include fiber optic cables 122 being cemented in place in the annular space between the casing string 104 and formation 114, or fiber optic cables 122 may be positioned within casing string 104 as shown in FIG. 3. Fiber optic cables 122 can also include fiber optic lines, fiber optic tubes, waveguides, optical waveguides, or any other fiber suitable for the intended purpose and understood by a person of ordinary skill in the art. Other types of permanent sensors may include surface and down-hole pressure sensors, where the pressure sensors may be capable of collecting data at rates up to 2,000 Hz or even higher.

The fiber optic cable 122 of the system 100 may house one or several optical fibers and the optical fibers may be single mode fibers, multi-mode fibers or a combination of single mode and multi-mode optical fibers. The system connected to the optical fibers may include DTS systems, Distributed Acoustic Sensing (DAS) Systems, Distributed Strain Sensing (DSS) Systems, quasi-distributed sensing systems where multiple single point sensors are distributed along an optical fiber/cable, or single point sensing systems where the sensors are located at the end of the cable. For each of the optical fibers 122, Brillouin measurement and Coherent Rayleigh measurement(s) are performed on the ground surface, to obtain distributions of Brillouin frequency shift and Rayleigh or enhanced backscatter based interferometric phase shift along the optical fibers. From these distributions of Brillouin frequency shift and Rayleigh-based interferometric phase shift, distributions of pressure, temperature, and strain along the fiber optic cable 122 can be determined simultaneously.

The system 100 may operate using various sensing principles. One example includes a DTS system based on inelastic Raman scattering with comparison of Stokes and Antistokes signal intensities to derive localized fiber temperature. Another example includes an optical phase change sensing-based system, such as a DAS system, which is based on interferometric sensing principles using a highly coherent laser and homodyne or heterodyne detection techniques, where the system may sense optical signal phase and/or intensity changes due to constructive or destructive interference along said fibers, due to changes in optical path length from temperature or strain perturbations. Another example includes a strain sensing system, such as a DSS using integrated dynamic strain measurements based on interferometric sensors or static strain sensing measurements using Brillouin scattering. Brillouin-based DSS systems sense both strain and temperature via inelastic scattering, where an acoustic phonon vibration is generated near 11 GHz in silica optical fiber and can be demodulated to measure phonon frequency shift, which is a function of strain and/or temperature. Another example includes quasi-distributed sensors based on Fiber Bragg Gratings (FBGs) where a wavelength shift is detected or multiple FBGs or multiple fibers are used to form Fabry-Perot, Mach-Zehnder, Michelson, or Sagnac type interferometric sensors for phase based sensing, or single point fiber optic sensors based on Fabry-Perot or FBG or intensity-based sensors.

Electrical sensors may be pressure sensors based on quartz crystal type sensors or vibrating wire strain gauge based sensors or other commonly used sensing technologies. Pressure sensors, optical or electrical, may be housed in dedicated gauge mandrels or attached outside the casing string 104 in various configurations for down-hole deployment or deployed conventionally at the surface well head or flow lines.

Various hybrid approached where single point or quasi-distributed or distributed fiber optic sensors are mixed with e.g. electrical sensors are also anticipated. The fiber optic cable 122 may then include optical fiber and electrical conductors.

The DTS system may include a receiver 124 that is a DTS interrogator, which transmits approximately 2-meter long round-trip laser pulses (equivalent to a 10 ns round-trip delay time) into the fiber optic cable 122 for a 1 m one-way spatial resolution. By analyzing the reflected light using techniques such as Raman scattering, the DTS interrogator is able to calculate the distributed measurement pressure data from the distributed strain sensing data (by analyzing the power or intensity of the reflected light) and also the location of the event (by measuring the time it takes the backscattered light to return from its initial laser pulse injection time at t=0). Strain values based on the distributed measurement pressure data are recorded along the fiber optic cable 122 as a continuous profile. In one aspect, the DTS interrogator may transmit temperature data for various points along the fiber optic cable 122 using the communication link 130 described earlier.

Measurements from a DTS system, for example, may be used to determine locations for fluid inflow in the treatment well as the fluids from the surface are likely to be cooler than formation temperatures. Measurements in observation wells can be used to determine fluid communication between the treatment well and observation well, or to determine formation fluid movement.

DAS data can be used by the system 100 to determine fluid allocation in real-time as acoustic noise is generated when fluid flows through the casing string 104 and in through perforations into the formation 114. Phase and intensity based interferometric sensing systems are sensitive to temperature and mechanical as well as acoustically induced vibrations. DAS data can be converted from time series date to frequency domain data using Fast Fourier Transforms (FFT) and other transforms like wavelet transforms may also be used to generate different representations of the data. Various acoustic or vibrational frequency ranges can be used to fingerprint or derive characteristic acoustic spectral signatures for different wellbore measurement parameters and where e.g. low frequency signal changes may be attributed to formation strain changes or fluid movement and other frequency ranges may be indicative if fluid or gas movement.

Various filtering techniques may be applied by the system 100 generate indicators of events that may be of interest. Indicators may include formation movement due to growing natural fractures, formation stress changes during the fracturing operations and this effect may also be called stress shadowing, fluid seepage during the fracturing operation as formation movement may force fluid into and observation well and this may be detected, fluid flow from fractures, fluid and proppant flow from fracture hits. Each indicator may have a characteristic signature in terms of frequency content and/or amplitude and/or time dependent behavior, and these indicators may be. These indicators may also be present at other data types and not limited to DAS data.

DAS systems can also be used by the system 100 to detect various seismic events where stress fields and/or growing fracture networks generate microseimic events or where perforation charge events may be used to determine travel time between horizontal wells and this information can be used from stage to stage to determine changes in travel time as the formation 114 is fractured and filled with fluid and proppant. The DAS systems may also be used with surface seismic sources to generate vertical seismic profiles before, during and after a fracturing job to determine the effectiveness of the fracturing job as well as determine production effectiveness.

DSS data can be generated by the system 100 using various approaches and static strain data can be used to determine absolute strain changes over time. Static strain data is often measured using Brillouin based systems or quasi-distributed strain data from FBG based system. Static strain may also be used to determine propped fracture volume by looking at deviations in strain data from a measured strain baseline before fracturing a stage. It may also be possible to determine formation properties like permeability, poroelastic responses and leak off rates based on the change of strain vs time and the rate at which the strain changes over time. Dynamic strain data can be used in real-time to detect fracture growth through an appropriate inversion model, and appropriate actions like dynamic changes to fluid flow rates in the treatment well, addition of diverters or chemicals into the fracturing fluid or changes to proppant concentrations or types can then be used to mitigate detrimental effects.

Fiber Bragg Grating based systems may also be used for a number of different measurements. FBG's are partial reflectors that can be used as temperature and strain sensors, or can be used to make various interferometric sensors with very high sensitivity. FBG's can be used to make point sensors or quasi-distributed sensors where these FBG based sensors can be used independently or with other types of fiber optic based sensors. FBG's can manufactured into an optical fiber at a specific wavelength, and other system like DAS, DSS or DTS systems may operate at different wavelengths in the same fiber and measure different parameters simultaneously as the FBG based systems using Wavelength Division Multiplexing (WDM).

The sensors of system 100 can be placed in either the treatment well or monitoring well(s) to measure well communication. The treatment well pressure, rate, proppant concentration, diverters, fluids and chemicals may be altered to change the hydraulic fracturing treatment. These changes may impact the formation responses in several different ways. Stress fields may change, and this may generate microseismic effects that can be measured with DAS systems and/or single point seismic sensors like geophones. Fracture growth rates may change and this can generate changes in measured microseismic events and event distributions over time, or changes in measured strain using the low frequency portion or the DAS signal or Brillouin based sensing systems. Pressure changes due to poroelastic effects may be measured in the monitoring well. Pressure data may be measured in the treatment well and correlated to formation responses. Various changes in treatment rates and pressure may generate events that can be correlated to fracture growth rates.

Several measurements can be combined by system 100 to determine adjacent well communication, and this information can be used to change the hydraulic fracturing treatment schedule to generate desired outcomes.

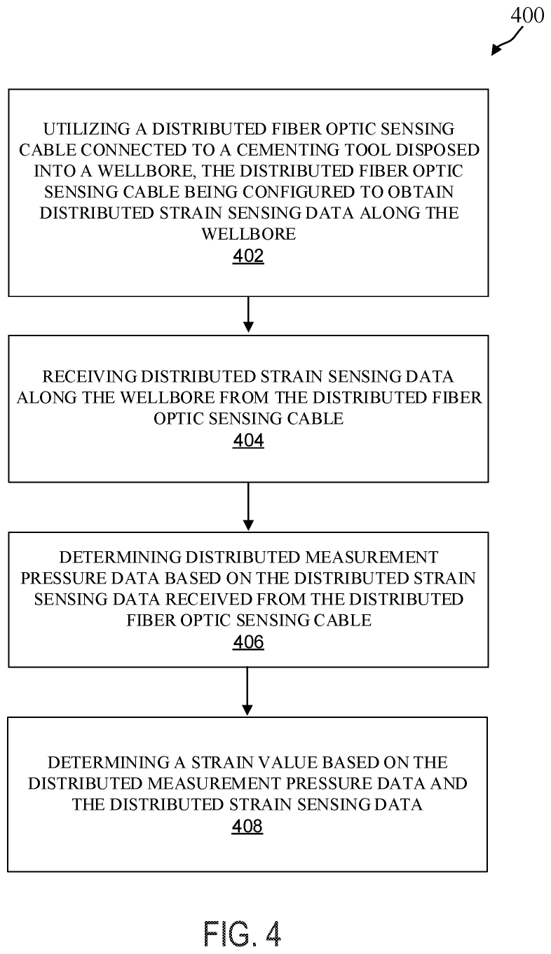

Having disclosed some example system components and concepts, the disclosure now turns to FIG. 4, which illustrate example method 400 for making distributed measurements along a wellbore using distributed strain sensing with a fiber optic cable during a cementing process. The steps outlined herein are exemplary and can be implemented in any combination thereof, including combinations that exclude, add, or modify certain steps.

At step 402, the method 400 can include utilizing a distributed fiber optic sensing cable connected to a cementing tool disposed into a wellbore. The distributed fiber optic sensing cable can be configured to obtain distributed strain sensing data along the wellbore. The cementing tool, for example a cement plug, can be positioned downhole in the casing string. The cement plug can be an upper cement plug that can be inserted into the casing string after a desired amount of cement has been injected into the casing string. In some examples, a dart for plugging a cement plug can be used in place of the cement plug.

In some implementations, the fiber optic cable connected to the cementing tool can be forced downhole by the injection of displacement fluid from the surface. A light source, such as a laser or LED, can move downhole with the cementing tool. The LED can generate a pulse of light, which can be transmitted to the receiver at the surface by the fiber optic cable. In some examples, a distributed sensor comprises a fiber optic cable and an associated interrogator unit for sending and receiving optical signals through the fiber optic cable.

At step 404, the method 400 can include receiving the distributed strain sensing data along the wellbore from the distributed fiber optic sensing cable. The distributed strain sensing data can be based on the backscattered optical signals. Light enters the fiber optic cable above the wellbore and a backscattered signal is measured by components at the surface. The backscattered light signal may contain both information about strain changes and location information indicating where along the fiber optic cable they occurred.

At step 406, the method 400 can include determining distributed measurement pressure data based on the distributed strain sensing data received from the distributed fiber optic sensing cable. There may be observed Rayleigh backscattered light, Raman backscattered light, and Brillouin backscattered light. A frequency analysis may be performed for the backscattered light. The backscattered light may be recorded along the length of the fiber optical cable. The amplitude and frequency shift of the Brillouin peaks relative to the Rayleigh peaks may be measured from which strain distributions along the fiber optical cable can be determined. The Brillouin and Rayleigh frequency shifts can be used to obtain measurement values for strain.

At step 408, the method 400 can include determining a strain value based on the distributed measurement pressure data and the distributed strain sensing data. A Brillouin frequency shift may be caused by strain applied to the fiber optic cable. Pressure applied can be measured by analyzing the frequency shift of the optical fiber. Temperature distributions may also be measured by way of Rayleigh frequency shift or Brillouin frequency shift. Pressure and temperature distributions may be provided on a display or user interface of a computing device.

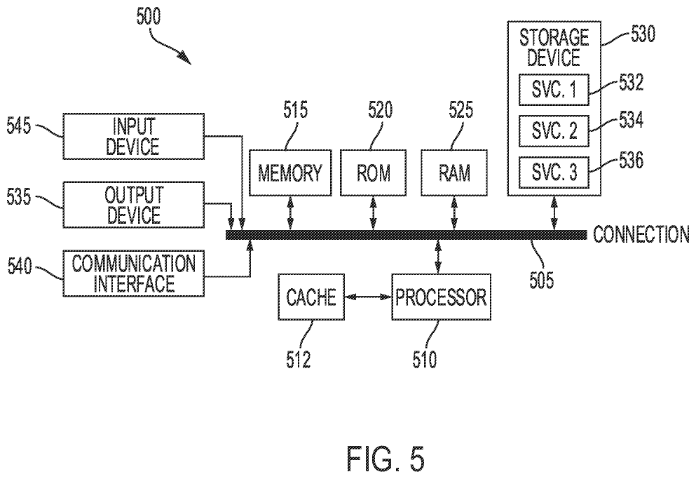

FIG. 5 illustrates an example computing device architecture 500, which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 5 illustrates an example computing device architecture 500 of a computing device, which can implement the various technologies and techniques described herein. The components of the computing device architecture 500 are shown in electrical communication with each other using a connection 505, such as a bus. The example computing device architecture 500 includes a processing unit (CPU or processor) 510 and a computing device connection 505 that couples various computing device components including the computing device memory 515, such as read only memory (ROM) 520 and random access memory (RAM) 525, to the processor 510.

The computing device architecture 500 can include a cache of high-speed memory connected directly with, in close proximity to, or integrated as part of the processor 510. The computing device architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other computing device memory 515 may be available for use as well. The memory 515 can include multiple different types of memory with different performance characteristics. The processor 510 can include any general purpose processor and a hardware or software service, such as service 1 532, service 2 534, and service 3 536 stored in storage device 530, configured to control the processor 510 as well as a special-purpose processor where software instructions are incorporated into the processor design. The processor 510 may be a self-contained system, containing multiple cores or processors, a bus, memory controller, cache, etc. A multi-core processor may be symmetric or asymmetric.

To enable user interaction with the computing device architecture 500, an input device 545 can represent any number of input mechanisms, such as a microphone for speech, a touch-sensitive screen for gesture or grail input, keyboard, mouse, motion input, speech and so forth. An output device 535 can also be one or more of a number of output mechanisms known to those of skill in the art, such as a display, projector, television, speaker device, etc. In some instances, multimodal computing devices can enable a user to provide multiple types of input to communicate with the computing device architecture 500. The communications interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. The storage device 530 can include services 532, 534, 536 for controlling the processor 510. Other hardware or software modules are contemplated. The storage device 530 can be connected to the computing device connection 505. In one aspect, a hardware module that performs a particular function can include the software component stored in a computer-readable medium in connection with the necessary hardware components, such as the processor 510, connection 505, output device 535, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data, which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1. A method comprising: utilizing a distributed fiber optic sensing cable connected to a cementing tool disposed into a wellbore, the distributed fiber optic sensing cable being configured to obtain distributed strain sensing data along the wellbore; receiving the distributed strain sensing data along the wellbore from the distributed fiber optic sensing cable; determining distributed measurement pressure data based on the distributed strain sensing data received from the distributed fiber optic sensing cable; and determining a strain value based on the distributed measurement pressure data and the distributed strain sensing data.

Statement 2. The system of statement 1, wherein the distributed fiber optic sensing cable is configured to transmit optical signals through the wellbore and transmit backscattered optical signals.

Statement 3. The system of statements 1-2, wherein the received distributed strain sensing data includes Brillouin measurements based on the backscattered optical signals.

Statement 4. The system of statements 1-3, wherein the optical signals are modulated with respect to frequency, amplitude, or phase.

Statement 5. The system of statements 1-4, further comprising measuring a shift in frequency of the backscattered optical signals.

Statement 6. The system of statements 1-5, wherein the received distributed strain sensing data includes Rayleigh measurements based on the backscattered optical signals.

Statement 7. The system of statements 1-6, wherein the strain value is at least one of pressure and temperature.

Statement 8. The system of statements 1-7, further comprising presenting the at least one of pressure and temperature on a user interface.

Statement 9. The system of statements 1-8, wherein the pressure and the temperature are measured simultaneously using the distributed fiber optic sensing cable.

Statement 10. The system of statements 1-9, wherein the cementing tool is a cementing top plug or a cementing top plug dart.

Statement 11. A system comprising: a cementing tool configured to be disposed into a wellbore; a distributed sensing system comprising: a distributed fiber optic sensing cable configured to connect to the cementing tool; and an interrogator positionable at a surface of the wellbore configured to: receive distributed strain sensing data along the wellbore from the distributed fiber optic sensing cable; and determine distributed measurement pressure data from the distributed strain sensing data; and a processor in communication with the distributed sensing system and configured to determine a strain value based on the distributed measurement pressure data and the distributed strain sensing data.

Statement 12. The system of statements 11, wherein the distributed fiber optic sensing cable is configured to transmit optical signals through the wellbore and transmit backscattered optical signals.

Statement 13. The system of statements 11-12, wherein the received distributed strain sensing data includes Brillouin measurements based on the backscattered optical signals.

Statement 14. The system of statements 11-13, wherein the received distributed strain sensing data includes Rayleigh measurements based on the backscattered optical signals.

Statement 15. The method of statement 11-14, wherein the optical signals are modulated with respect to frequency, amplitude, or phase.

Statement 16. The method of statement 11-15, wherein the distributed sensing system is at least one of a distributed temperature sensing system and a distributed strain sensing system.

Statement 17. The method of statements 11-16, wherein the strain value is at least one of pressure and temperature.

Statement 18. The method of statements 11-17, wherein the at least one of pressure and temperature is presented on a user interface.

Statement 19. The method of statements 11-18, wherein the pressure and the temperature are measured simultaneously using the distributed fiber optic sensing cable.

Statement 20. The method of statements 11-19, wherein the cementing tool is a cementing top plug or a cementing top plug dart.

What is claimed is:

1. A method comprising:
utilizing a distributed fiber optic sensing cable connected to a cementing tool disposed into a wellbore, the distributed fiber optic sensing cable being configured to obtain distributed strain sensing data along the wellbore;
receiving the distributed strain sensing data along the wellbore from the distributed fiber optic sensing cable;
determining distributed measurement pressure data based on the distributed strain sensing data received from the distributed fiber optic sensing cable; and
determining a strain value based on the distributed measurement pressure data and the distributed strain sensing data.

2. The method of claim 1, wherein the distributed fiber optic sensing cable is configured to transmit optical signals through the wellbore and transmit backscattered optical signals.

3. The method of claim 2, wherein the received distributed strain sensing data includes Brillouin measurements based on the backscattered optical signals.

4. The method of claim 2, wherein the optical signals are modulated with respect to frequency, amplitude, or phase.

5. The method of claim 4, further comprising measuring a shift in frequency of the backscattered optical signals.

6. The method of claim 2, wherein the received distributed strain sensing data includes Rayleigh measurements based on the backscattered optical signals.

7. The method of claim 1, wherein the strain value is at least one of pressure and temperature.

8. The method of claim 7, further comprising presenting the at least one of pressure and temperature on a user interface.

9. The method of claim 7, wherein the pressure and the temperature are measured simultaneously using the distributed fiber optic sensing cable.

10. The method of claim 1, wherein the cementing tool is a cementing top plug or a cementing top plug dart.

11. A system comprising:
a cementing tool configured to be disposed into a wellbore;
a distributed sensing system comprising:
a distributed fiber optic sensing cable configured to connect to the cementing tool; and
an interrogator positionable at a surface of the wellbore configured to:
receive distributed strain sensing data along the wellbore from the distributed fiber optic sensing cable; and
determine distributed measurement pressure data from the distributed strain sensing data; and
a processor in communication with the distributed sensing system and configured to determine a strain value based on the distributed measurement pressure data and the distributed strain sensing data.

12. The system of claim 11, wherein the distributed fiber optic sensing cable is configured to transmit optical signals through the wellbore and transmit backscattered optical signals.

13. The system of claim 12, wherein the received distributed strain sensing data includes Brillouin measurements based on the backscattered optical signals.

14. The system of claim 12, wherein the received distributed strain sensing data includes Rayleigh measurements based on the backscattered optical signals.

15. The system of claim 12, wherein the optical signals are modulated with respect to frequency, amplitude, or phase.

16. The system of claim 11, wherein the distributed sensing system is at least one of a distributed temperature sensing system and a distributed strain sensing system.

17. The system of claim 11, wherein the strain value is at least one of pressure and temperature.

18. The system of claim 17, wherein the at least one of pressure and temperature is presented on a user interface.

19. The system of claim 17, wherein the pressure and the temperature are measured simultaneously using the distributed fiber optic sensing cable.

20. The system of claim 11, wherein the cementing tool is a cementing top plug or a cementing top plug dart.
